(19) United States
(12) Patent Application Publication
(10) Pub. No.: US 2015/0375685 A1
(43) Pub. Date: Dec. 31, 2015

(54) CUSTOMIZABLE CONSOLE FOR A MOTOR VEHICLE

(71) Applicant: FORD GLOBAL TECHNOLOGIES, LLC, Dearborn, MI (US)

(72) Inventors: Venkatesh Krishnan, Canton, MI (US); Brandon Buckhalt, Belleville, MI (US)

(21) Appl. No.: 14/315,368

(22) Filed: Jun. 26, 2014

(51) Int. Cl. B60R 7/04; B60R 11/02; B60N 3/10

(52) U.S. Cl. CPC B60R 7/04; B60N 3/104; B60R 11/0241; B60R 11/0252; B60R 2011/0294

(57) ABSTRACT

A customizable console system for a motor vehicle includes two or more console organizers of substantially any desired configuration, a base unit having a receiver for alternately holding one of the organizers and a storage receiver for receiving and holding any of the organizers not in use and held in the receiver of the base unit.

### TECHNICAL FIELD

This document relates generally to interior systems for motor vehicles and, more particularly, to a customizable console with multiple configurations for enhanced versatility in meeting the needs and preferences of a vehicle operator.

### BACKGROUND

Automotive vehicle consoles are well known in the art. Typically, the console is placed between the driver and front passenger seats. However rear seat consoles have become common in SUV's and some other vehicles. The console typically provides many functions, operating as an armrest, a storage unit, a cup holder and for other purposes.

In general, vehicle operators have very unique needs and personal preferences when it comes to the use and desired configuration of the console. Some operators may want two or more cup holders. Other operators may not want any cup holders. Some operators may want a simple storage tray while others may desire a compartmentalized console with storage specifically adapted for a cell phone, a computer tablet, a garage door opener, sunglasses or other purposes.

In addition vehicle operator preferences may change depending on the circumstances or application. For example, during working hours a traveling salesman may desire a console that holds his cell phone, his tablet or his laptop in a position where it may be readily accessed. In contrast, when that same person is using the vehicle for a family vacation, he may desire a console equipped with two cup holders and a compartment for sunglasses and another compartment to hold change for paying turnpike tolls.

This document relates to a customizable console for a motor vehicle allowing the console be organized in multiple configurations to meet the individual preferences and changing needs of a vehicle operator. In this way it is possible to provide enhanced utility and increased operator satisfaction.

### SUMMARY

In accordance with the purposes and benefits described herein, a customizable console is provided for a motor vehicle. The customizable console comprises: (a) a first console organizer having a first configuration, (b) a second console organizer having a second configuration, (c) a base unit having a first receiver for alternately holding the first console organizer or the second console organizer and (d) a storage receiver for receiving and holding the first console organizer, the second console organizer or both of the first and second console organizers. In one possible embodiment the storage receiver is at least one elastic strap. In another possible embodiment the storage receiver is at least one strap having a fastener to secure the strap around the first console organizer, the second console organizer or both console organizers.

In one possible embodiment, the storage receiver is remotely located relative to the base unit. Thus, for example, the storage receiver may be located under a seat such as the front passenger seat. In another possible embodiment the storage receiver is located in the trunk of the vehicle.

In one embodiment, the first receiver forms a storage receptacle when the first receiver is not in use to receive and hold either of the first and second console organizers. In one embodiment the first organizer configuration is different from the second organizer configuration. In one embodiment the first configuration includes at least one cup holder and a cell phone storage slot. In one embodiment the second configuration includes at least one cup holder and a computer tablet storage compartment.

In one possible embodiment, the base unit includes an electronic cable connection. Such a connection may allow power to be provided to electronic devices such as a cell phone, laptop or iPad music device.

In one possible embodiment, a cooperating fastening system is provided for securing either of the first and second organizers to the first receiver. In one possible embodiment the base unit is secured to the floor of a vehicle. The point of attachment may be between the front seats of the vehicle, between rear seats of the vehicle or alternately between front and rear seats of the vehicle depending upon the preference of the vehicle operator.

In one possible embodiment, the base unit further includes a temperature control unit for heating and cooling a cup holder in either of the first console organizer or the second console organizer. In another possible embodiment a third console organizer is provided with a third configuration. In yet another possible embodiment a fourth console organizer is provided with a fourth configuration. In this embodiment a second storage receiver may be provided for receiving and holding the third console organizer, the fourth console organizer or both of the third and fourth console organizers.

In the following description, there is shown and described several preferred embodiments of the customizable console. As it should be realized, the customizable console is capable of other, different embodiments and its several details are capable of modification in various, obvious aspects all without departing from the console as set forth and described in the following claims. Accordingly, the drawings and descriptions should be regarded as illustrative in nature and not as restrictive.

### BRIEF DESCRIPTION OF THE DRAWINGS

The accompanying drawings incorporated herein and forming a part of the specification, illustrate several aspects of the console and together with the description serve to explain certain principles thereof. In the drawings:

FIG. 1 is a partially exploded perspective view illustrating the base unit and the first and second console organizers.

FIG. 2a is a detailed perspective view of one possible embodiment of base unit receiver in the absence of any console organizer.

FIG. 2b is a detailed perspective view of the base unit with the first console organizer received and held by the receiver.

FIG. 2c is a detailed perspective view of the console with the second console organizer received and held in the receiver.

FIG. 3 is a schematical view illustrating the back side of the front passenger seat and the storage receiver holding a console organizer.

FIG. 4 is a schematic illustration of the sidewall of the trunk of the vehicle incorporating a storage receiver holding an extra console organizer.

FIG. 5a is a schematical top plan view of a vehicle interior wherein the console is secured to a floor of the vehicle between the front seats.

FIG. 5b is a schematical top plan view of a vehicle interior wherein the console is secured to a floor of the vehicle between the rear seats.

Reference will now be made in detail to the present preferred embodiments of the console, examples of which are illustrated in the accompanying drawings.

### DETAILED DESCRIPTION

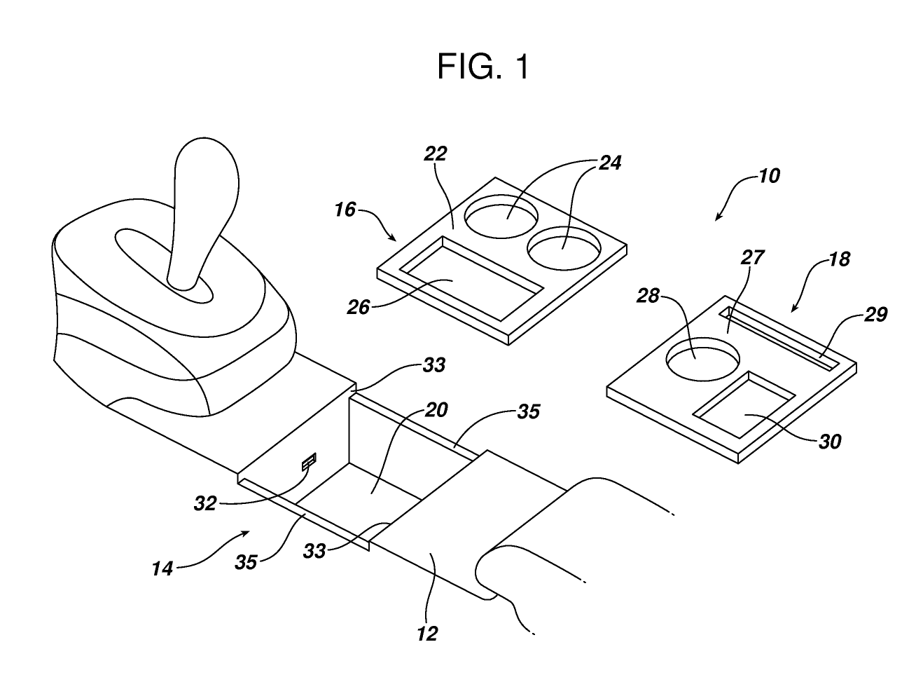

Reference is now made to FIG. 1 which is a perspective view of a customizable console 10 adapted for use in a motor vehicle. The console 10 includes a base unit 12 that is mounted to the floor of the vehicle. The base unit 12 includes a first receiver 14. The receiver 14 alternately receives and holds a first console organizer, generally designated by reference numeral 16, or a second console organizer, generally designated by reference numeral 18.

As illustrated in FIG. 1, the receiver 14 includes a cavity 20 which forms a storage receptacle for holding sunglasses, writing pens, a note pad and the like when the receiver is not used to receive and hold either of the first and second console organizers 16, 18.

In the illustrated embodiment the first organizer 16 includes a decorative fascia 22, two cup holders 24 and a cell phone storage slot 26. In contrast, the second organizer 18 includes a decorative fascia 27, one cup holder 28, a computer tablet storage compartment 29 and a coin tray 30. In an alternative embodiment, an electronic cable connection such as a USB port 32 may be provided on the receiver 14 and/or on the second organizer 18 if desired. Alternatively, or in addition, the port 32 may be a simple power outlet.

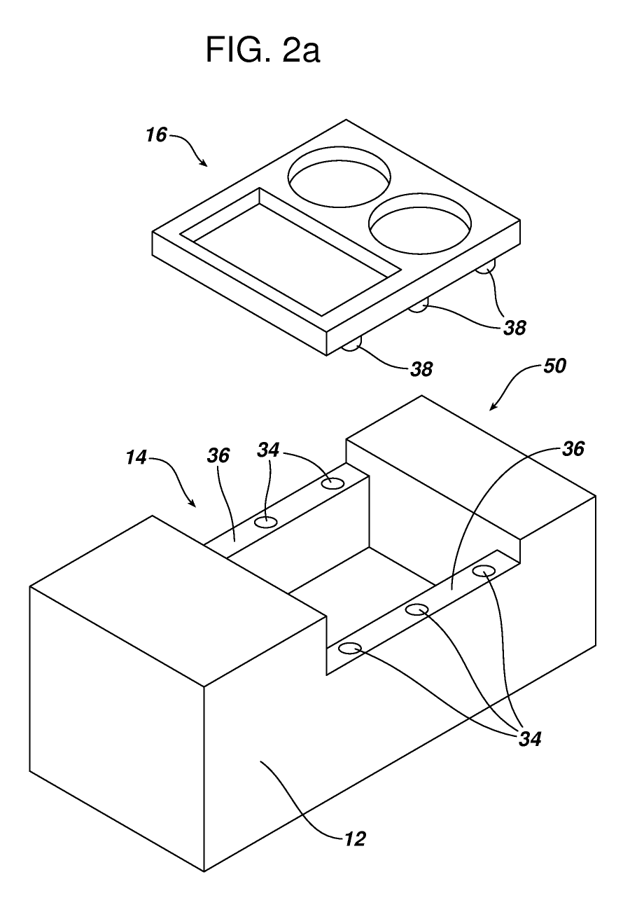

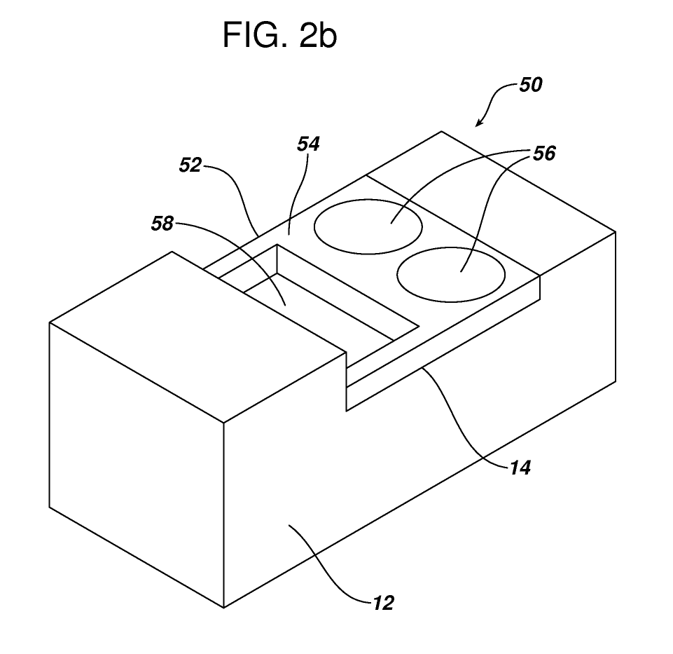

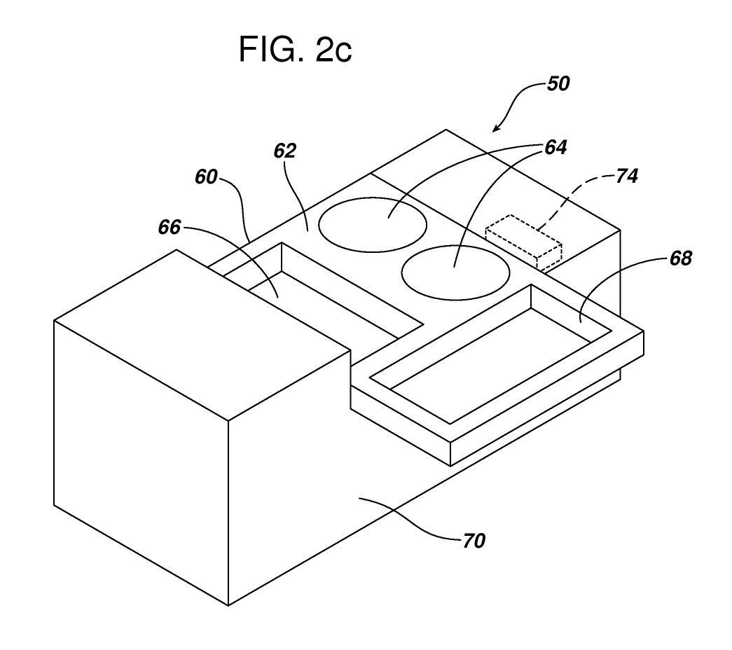

In one possible embodiment the first and second organizers 16, 18 are sized and shaped to simply nest in the receiver 14 between the front and rear lips 33 of the base unit 12. Small downwardly depending side flanges (not shown) on the organizers 16, 18 would engage the inner surfaces of the base unit sidewalls 35 to keep the organizers from slipping out of position. In another possible embodiment the organizers 16, 18 are sized to friction fit. In another alternative embodiment a cooperating fastening system is provided for securing either of the organizers 16, 18 in the receiver 14. In the embodiment illustrated in FIG. 2a, a series of locking apertures 34 are provided in the top opposing sidewalls 36 of the receiver 14. Resilient tabs 38 projecting from the bottom of the organizer 16 or 18 are aligned with and engage the locking apertures 34 with a snap fit. In still another possible embodiment the fastening system comprises engagement tabs and cooperating tracks or notches as described in U.S. Pat. No. 8,714,613 to Gillis et al. and assigned to Ford Global Technologies, LLC. It should be appreciated that these are examples of just a few of the possible fastening systems that may be utilized to secure organizers 16, 18 to the receiver 14 of the console 10 and the scope of this document should not be strictly limited to these particular examples.

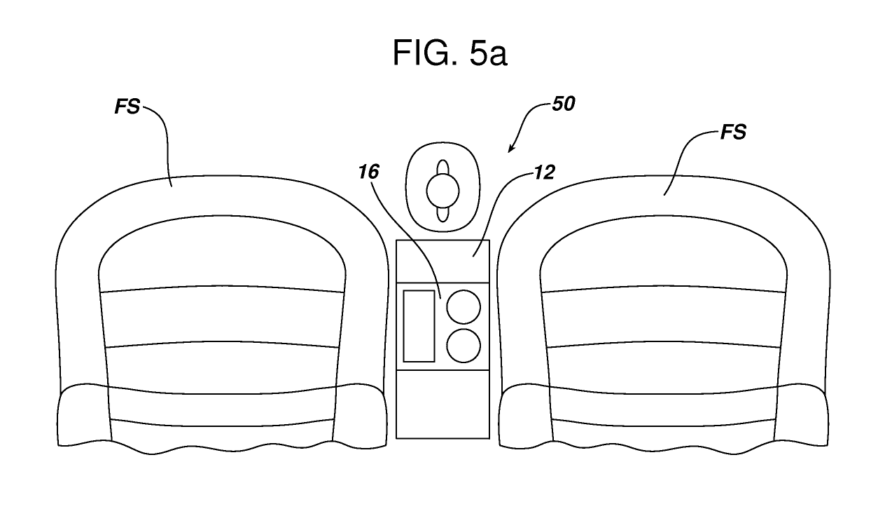

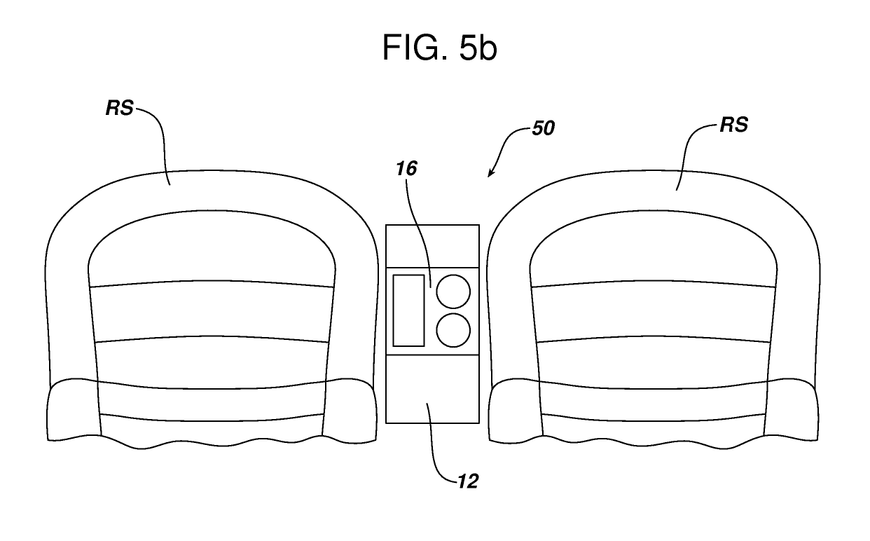

The alternative embodiment of the console 50 illustrated in FIG. 2a is of the type that is secured to the floor of the vehicle by an appropriate latching or mounting system of a type known in the art and may be positioned between the front seats FS, between the rear seats RS or alternatively and selectively between the front seats or the rear seats as desired by the vehicle operator. See particularly FIGS. 5a and 5b. FIG. 2b is an illustration of the console 50 including a third organizer 52 received and held in receiver 14. This organizer 52 includes a decorative facia 54 that fits flush with the face of the base unit 12, two cup holders 56 and a tissue box organizer 58. FIG. 2c illustrates the console 50 wherein the receiver 14 holds a fourth organizer 60 including a decorative facia 62, two cup holders 64, and a utility compartment 66 for sunglasses, a garage door opener, tollbooth change or the like. As should be further appreciated, the fourth organizer 60 includes an outrigger 68 which projects beyond the sidewall 70 of the console 50. The outrigger 68 includes a tray 72 which may be adapted to receive and hold any number of desired items. In some embodiments, the tray 72 may be replaced with a slot that is open at the bottom so as to receive and hold longer items such as an umbrella.

It should be appreciated that the console 10, the console 50 or any of the organizers 16, 18, 52, 60 may include a temperature control unit 74 (see FIG. 2c) which is connected to and powered by the vehicle operating system to cool and/or heat the cup holders 64 as desired by the operator to keep a warm drink warm or a cold drink cold in substantially any ambient conditions.

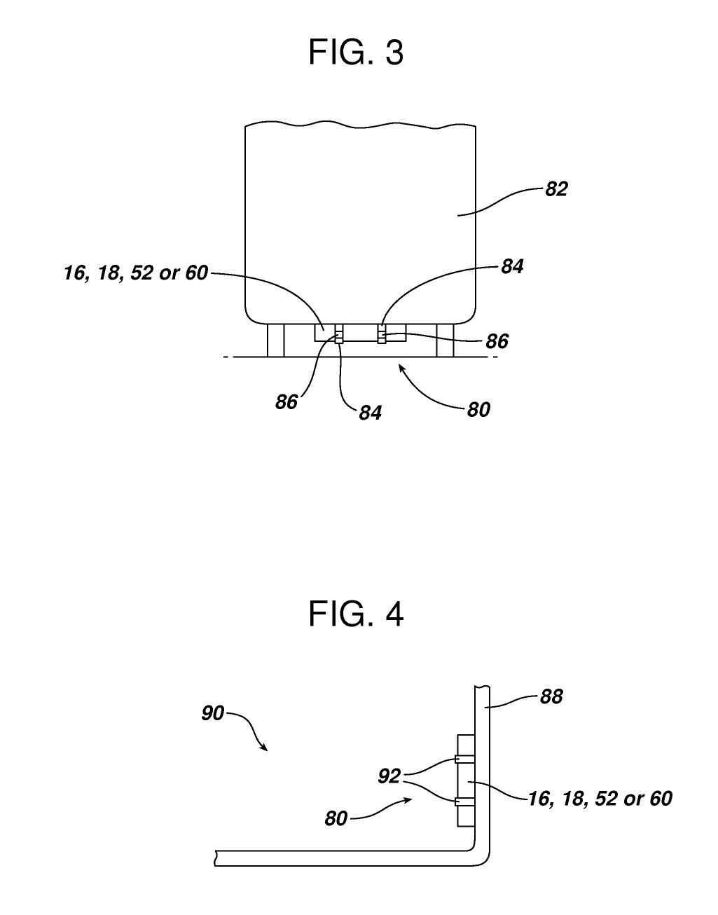

As illustrated in FIG. 3, the customizable console system also includes a storage receiver 80 for receiving and holding any console organizer 16, 18, 52, 60 not currently in use and being held in the receiver 14 of one of the consoles 10, 50. As illustrated in FIG. 3, the receiver 80 is positioned under the front passenger seat 82. As illustrated, the storage receiver 80 comprises two straps 84 with each strap including a cooperating hook and loop fastener 86 so that the straps may be adjusted to hold one or more console organizers 16, 18, 52, 60.

In contrast, FIG. 4 schematically illustrates a storage receiver 80 positioned on a sidewall 88 within a trunk 90. In this embodiment the storage receiver 80 comprises a pair of elastic straps 92.

It should be appreciated that the underside of the passenger seat 82 and the sidewall 88 of the trunk 90 are just too possible locations for a storage receiver 80 within the vehicle and that these are presented for purposes of illustration and should not be considered as limiting. Further, the storage receiver 80 may take a form other than straps 84, 92 including, but not limited to, a rack and/or a small storage compartment in a door, sidewall or floor of the vehicle.

In summary, numerous benefits result from the concepts disclosed in this document. The customizable console 10, 50 allows an operator to better tailor the form and function of the console to meet his needs and preferences. In fact, in one possible extension of this concept, the customer could design his own organizer so long as it was sized to fit the base unit 12. That organizer would then be manufactured to the customer's specification and supplied to him through the local automobile dealership.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A customizable console system for a motor vehicle, comprising:
a first console organizer having a first configuration;
a second console organizer having a second configuration;
a base unit having a first receiver for alternately holding said first console organizer or said second console organizer; and
a storage receiver for receiving and holding said first console organizer or said second console organizer or said first and second console organizers.

2. The console of claim 1, wherein said storage receiver is at least one elastic strap.

3. The console of claim 1, wherein said storage receiver is at least one strap having a fastener to secure said strap around said first console organizer, said second console organizer or said first and second console organizers.

4. The console of claim 1, wherein said storage receiver is remotely located relative to said base unit.

5. The console of claim 4, wherein said storage receiver is located under a seat of said vehicle.

6. The console of claim 4, wherein said storage receiver is located in a trunk of said vehicle.

7. The console of claim 1, wherein said first receiver forms a storage receptacle when said first receiver is not in use to receive and hold either of said first and second console organizers.

8. The console of claim 1, wherein said first configuration is different from said second configuration.

9. The console of claim 8, wherein said first configuration includes at least one cup holder and a cell phone storage slot.

10. The console of claim 9, wherein said second configuration includes at least one cup holder and a computer tablet storage compartment.

11. The console of claim 1, wherein said base unit includes an electronic cable connection port.

12. The console of claim 1, further including a cooperating fastening system for securing either of said first console organizer or said second console organizer to said first receiver.

13. The console of claim 1, wherein said base unit is secured to a floor of said vehicle.

14. The console of claim 13, wherein said base unit is secured to said floor between front seats of said vehicle.

15. The console of claim 13, wherein said base unit is secured to said floor between rear seats of said vehicle.

16. The console of claim 13, wherein said base unit may be secured to said floor of said vehicle in a first position between front seats of said vehicle or a second position between rear seats of said vehicle.

17. The console of claim 1, further including a temperature control unit in said base unit for heating and cooling a cup holder in either of said first console organizer or said second console organizer.

18. The console of claim 1, further including a third console organizer having a third configuration.

19. The console of claim 18, further including a fourth console organizer having a fourth configuration.

20. The console of claim 19, further including a second storage receiver for receiving and holding said third console organizer, said fourth console organizer or said third and fourth console organizers.
